(19) United States
(12) Patent Application Publication
(10) Pub. No.: US 2014/0220425 A1
(43) Pub. Date: Aug. 7, 2014

(54) ACCUMULATOR

(71) Applicant: KABUSHIKI KAISHA TOYOTA JIDOSHOKKI, Aichi-ken (JP)

(72) Inventors: Motoaki OKUDA, Kariya-shi (JP); Atsushi MINAGATA, Kariya-shi (JP)

(73) Assignee: KABUSHIKI KAISHA TOYOTA JIDOSHOKKI, Aichi-ken (JP)

(21) Appl. No.: 14/170,866

(22) Filed: Feb. 3, 2014

(30) Foreign Application Priority Data
Feb. 6, 2013 (JP) 2013-021493

(51) Int. Cl. H01M 2/36

(52) U.S. Cl. CPC H01M 2/365
USPC 429/185

(57) ABSTRACT

An accumulator includes a case accommodating an electrode assembly and electrolyte. The case includes a recess, a port, and a cap. The recess extends into a wall of the case. The port extends through the case wall in the recess. The cap is welded to the case wall around the recess to close the recess.

### BACKGROUND OF THE INVENTION

The present invention relates to an accumulator including a case that accommodates an electrode assembly and electrolyte.

A vehicle such as an electric vehicle (EV) or a plug-in hybrid vehicle (PHV) includes a rechargeable battery such as a lithium-ion battery. The rechargeable battery functions as an accumulator that accumulates energy to be supplied to a motor. Japanese Laid-Open Patent Publication No. 11-111245 describes an example of such a type of rechargeable battery. The rechargeable battery includes a case that accommodates an electrode assembly and electrolyte.

The rechargeable battery case includes, for example, a liquid injection port, through which the electrolyte is injected, and a gas ventilation port, from which gas is released when produced during an aging process that activates the assembled battery. These ports are closed by caps in the final product.

### SUMMARY OF THE INVENTION

As disclosed in Japanese Laid-Open Patent Publication No. 11-111245, when closing the ports, the caps are welded to the case. However, the electrolyte may be dispersed when injected into the liquid injection port. Such electrolyte may collect on the wall of the case around the liquid injection port and cause defective welding that adversely affects the hermetic seal of the case.

It is an object of the present invention to provide an accumulator that does not adversely affect the hermetic seal of the case.

One aspect of the present invention is an accumulator including a case that accommodates an electrode assembly and electrolyte. The case includes a recess that extends into a wall of the case, a port that extends through the case wall in the recess, and a cap welded to the case wall around the recess to close the recess.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a perspective view of a rechargeable battery;

FIG. 2 is a plan view showing a case cover of the rechargeable battery and a cap coupled to the cover;

FIG. 3 is a cross-sectional view taken along line 3-3 in FIG. 2;

FIG. 4 is a schematic diagram illustrating a process for injecting electrolyte into the rechargeable battery of FIG. 1;

FIG. 5 is a cross-sectional diagram showing a further example of a recess; and

FIG. 6 is a plan view showing another example of a recess.

### DETAILED DESCRIPTION OF THE INVENTION

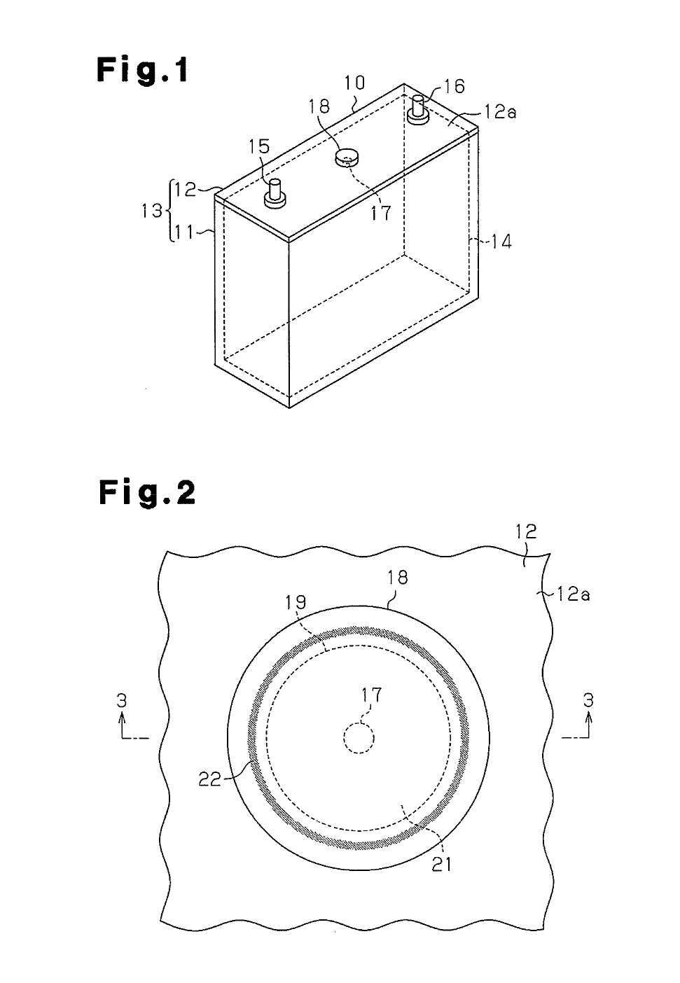

One embodiment of an accumulator will now be described with reference to FIGS. 1 to 4.

As shown in FIG. 1, a rechargeable battery 10 serving as the accumulator includes a box-shaped case 13. The case 13 includes a case body 11 and a cover 12, which covers an opening of the case body 11. The case 13 accommodates an electrode assembly 14 and electrolyte (not shown). A positive terminal 15 and a negative terminal 16 are electrically connected to the electrode assembly 14. The positive terminal 15 and the negative terminal 16 are exposed from the cover 12 to the exterior of the case 13.

The electrode assembly 14 includes positive electrodes, negative electrodes, and separators that insulate the positive and negative electrodes. Each positive electrode includes a positive electrode active material layer that is formed by a positive electrode metal foil (aluminum foil in the present embodiment) and a positive electrode active material applied to the two opposite sides of the positive electrode metal foil. Each negative electrode includes a negative electrode active material layer that is formed by a negative electrode metal foil (copper foil in the present embodiment) and a negative electrode active material applied to the two opposite sides of the negative electrode metal foil. The electrode assembly 14 has a stacked structure in which the positive electrodes and the negative electrodes are alternately stacked with separators arranged between adjacent electrodes.

The cover 12 serves as a wall of the case 13, that is, a case wall. An injection port 17 used to inject electrolyte into the case body 11 extends through the cover 12. The injection port 17 extends from an outer surface 12a of the cover 12 located at the outer side of the case 13 to the inner surface 12b of the cover 12 located at the inner side of the case 13. The injection port 17 is closed by a cap 18. The cap 18 is fixed to the outer surface 12a of the cover 12 and exposed from the case 13.

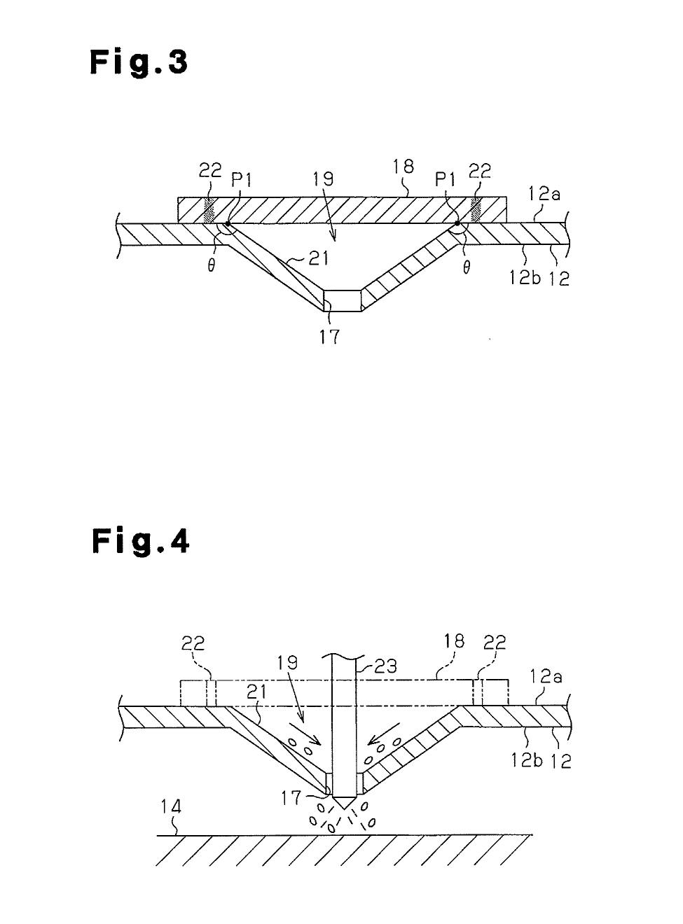

As shown in FIGS. 2 and 3, the injection port 17 is located in the bottom of a recess 19, which extends into the cover 12. That is, the injection port 17 is located in the deepest portion of the recess 19. The recess 19 is circular as viewed from above and includes a sloped surface 21 that extends toward the deepest portion. The sloped surface 21 in this embodiment downwardly extends toward the injection port 17, which is located at the deepest portion. More specifically, the sloped surface 21 is sloped in a conical manner to extend into the case 13 toward the injection port 17. The sloped surface 21 forms part of the outer surface 12a of the cover 12. The recess 19 is formed so that the angle θ between the sloped surface 21 and the portion of the outer surface 12a connected to the sloped surface 21 is an obtuse angle.

The cap 18 is a circular plate as viewed from above. The cap 18 is shaped to cap the opening of the recess 19 at a connection point P1 connecting the sloped surface 21 of the recess 19 and the outer surface 12a around the sloped surface 21. The cap 18 is welded to the outer surface 12a of the cover 12 around the outer side of the recess 19. In this embodiment, the cap 18 is joined with the outer surface 12a of the cover 12 at a welded portion 22, which is circular as viewed from above.

The operation of the present embodiment will now be described.

The injection of electrolyte into the case body 11 is performed after the electrode assembly 14 is accommodated in the case body 11 and the opening of the case body 11 is closed by the cover 12.

Referring to FIG. 4, when injecting the electrolyte, an injection nozzle 23 is inserted into the injection port 17, and the electrolyte is injected into the case body 11 through the injection nozzle 23. Since the electrode assembly 14 has already been accommodated in the case body 11, the electrolyte injected into the case body 11 splashes when striking the electrode assembly 14. The splashed electrolyte collects on portions of the inner surface 12b of the cover 12 that form the recess 19. This limits the amount of the electrolyte expelled from the gap between the injection port 17 and the injection nozzle 23. Even if some of the electrolyte is expelled from the gap between the injection port 17 and the injection nozzle 23, the expelled electrolyte would have a tendency to collect on the sloped surface 21 surrounding the injection port 17. Thus, the expelled electrolyte would not easily reach the outer surface 12a of the cover 12 at the outer side of the recess 19, that is, the surface surrounding the recess 19. After the injection of the electrolyte, the cap 18 is welded to the outer surface 12a of the cover 12 at the outer side of the recess 19. This closes the recess 19.

Accordingly, the present embodiment has the advantages described below.

(1) The cover 12 includes the inwardly extending recess 19 and the injection port 17, which is located in the recess 19. During the injection of electrolyte, the recess 19 limits the amount of electrolyte splashed to the outside. This limits the collection of the electrolyte where the cap 18 is welded and ensures that the cap 18 is welded to the cover 12. This makes it less likely that defective welding will adversely affect the hermetic seal of the case 13.

(2) The injection port 17 is located at the deepest portion of the recess 19. This increases the distance from the location where the cap 18 is welded to the port 17 and further limits the collection of electrolyte at the weld location.

(3) The recess 19 includes the sloped surface 21. Thus, even when the electrolyte is expelled from the injection port 17, the sloped surface 21 limits the escape of the electrolyte from the recess 19. That is, the electrolyte expelled from the injection port 17 collects on the sloped surface 21 but remains in the recess 19. Further, in this embodiment, the sloped surface 21 downwardly extends toward the injection port 17. This returns the electrolyte collected on the sloped surface 21 into the case 13. Thus, the electrolyte remaining in the recess 19 is reduced, and electrolyte does not have to be wiped off or may easily be wiped off from the recess 19. This improves efficiency when manufacturing the rechargeable battery 10.

(4) Since the recess 19 is circular as viewed from above, the cover 12 may be easily machined. This keeps the manufacturing cost of the rechargeable battery 10 low.

It should be apparent to those skilled in the art that the present invention may be embodied in many other specific forms without departing from the spirit or scope of the invention. Particularly, it should be understood that the present invention may be embodied in the following forms.

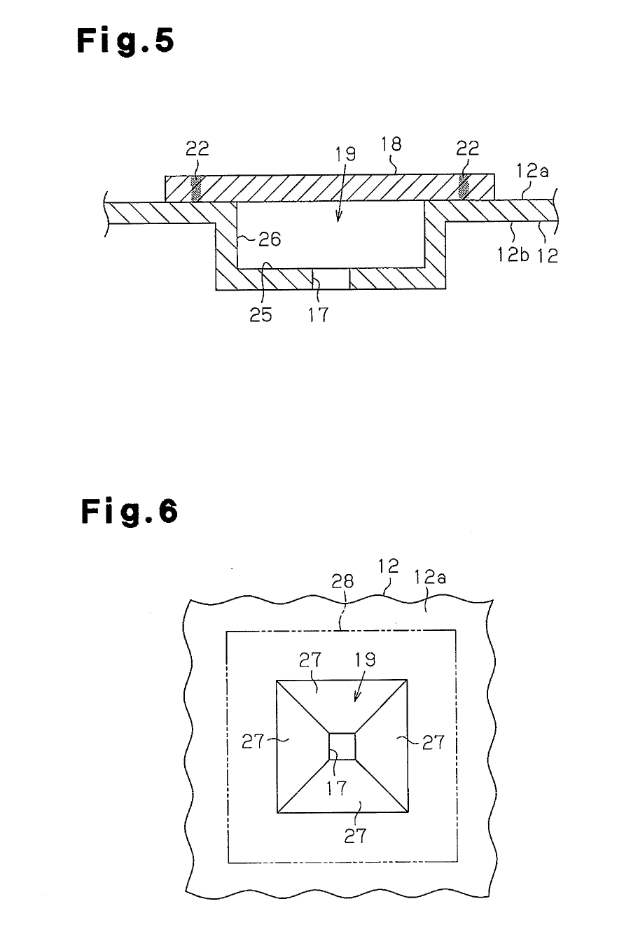

Referring to FIG. 5, the shape of the recess 19 may be changed. The recess 19 of FIG. 5 is shaped so that a surface of a bottom portion 25 including the injection port 17 is connected by a vertical wall surface 26 to the outer surface 12a of the cover 12 surrounding the bottom portion 25. Like the structure of FIG. 3, the portion of the inner surface 12b of the cover 12 where the recess 19 is formed in FIG. 5 limits the amount of electrolyte that is expelled to the outside. Further, the distance between the injection port 17 and the outer surface 12a of the cover 12 located at the outer side of the recess 19 is increased. Thus, little or no electrolyte reaches the outer surface 12a.

Referring to FIG. 6, the recess 19 may be tetragonal as viewed from above. In this case, the recess 19 includes sloped surfaces 27 that downwardly extend toward the injection port 17. This obtains the same advantages as the embodiment described above. As shown in the drawings by broken lines, the recess 19 of this example is closed by a cap 28 that is, for example, tetragonal as viewed from above.

The sloped surface 21 does not necessarily have to extend toward the injection port 17 as long as it extends toward the bottom, or deepest portion, of the recess 19. For example, in the recess 19 shown in FIG. 5, the wall surface 26 may be a sloped surface, and the bottom portion 25 may include a surface extending between the sloped surface and the injection port 17. This example may be applied in the same manner to the example shown in FIG. 6. In such a structure in which a sloped surface extends toward the deepest portion, in the same manner as the above embodiment, even when the electrolyte is expelled from the injection port 17, the sloped surface limits the escape of electrolyte from the recess 19.

The recess 19 is not restricted to the shapes of the examples shown in FIGS. 5 and 6 and may have any shape.

The port arranged in the recess 19 does not have to be the injection port 17 and may be a port used for other purposes. For example, a port that releases the gas produced during an aging process from the case 13 may be arranged in the recess 19. In this case, even when electrolyte is emitted from the port together with the gas, the electrolyte is collected in the recess 19. Thus, when closing the recess 19 after such a process, the same advantages as the above embodiment may be obtained.

The cap 18 does not have to be shaped to close the opening of the recess 19. For example, the cap 18 may be shaped so that it is plugged into the recess 19 to entirely seal the recess 19.

As long as the cap 18 closes the opening of the recess 19, the cap 18 may have any shape. For example, the cap 18 may be tetragonal as viewed from above.

The rechargeable battery 10 may be a lithium-ion rechargeable battery or any other type of a rechargeable battery. Any rechargeable battery may be used as long as ions are moved and charges are transferred between positive and negative active material layers. Further, a capacitor may be used as the accumulator.

The rechargeable battery 10 of the present embodiment may be installed as a power supply in a vehicle such as an automobile and an industrial vehicle. Alternatively, the rechargeable battery 10 of the present embodiment may be applied to a stationary accumulator.

The structure of the recess 19 is not limited to the stacked type rechargeable battery 10 and may also be applied to the case of a winding type rechargeable battery in which strips of positive and negative electrodes are wound into layers that are stacked upon one another.

The present examples and embodiments are to be considered as illustrative and not restrictive, and the invention is not to be limited to the details given herein, but may be modified within the scope and equivalence of the appended claims.

1. An accumulator comprising a case that accommodates an electrode assembly and electrolyte, the case comprising:
a recess that extends into a wall of the case;
a port that extends through the case wall in the recess; and
a cap welded to the case wall around the recess to close the recess.

2. The accumulator according to claim 1, wherein the port is located at a deepest portion of the recess.

3. The accumulator according to claim 1, wherein the recess includes a sloped surface extending toward a deepest portion of the recess.

4. The accumulator according to claim 1, wherein the recess is circular as viewed from above.

5. The accumulator according to claim 1, wherein the port is an injection port used to inject the electrolyte into the case.

6. The accumulator according to claim 1, wherein the accumulator is a rechargeable battery.
